(19) United States
(12) Patent Application Publication
(10) Pub. No.: US 2011/0152480 A1
(43) Pub. Date: Jun. 23, 2011

(54) Catalysts for Polymerizing Olefins and Method Thereof

(75) Inventors: Yuri Gulevich, Konigstein (DE); Fabrizio Piemontesi, Ferrara (IT); Benedetta Gaddi, Ferrara (IT); Simona Guidotti, Bologna (IT); Ilya E. Nifant'ev, Moscow (RU); Andrey Lyubimtsev, Moscow (RU)

(73) Assignee: BASELL POLIOLEFINE ITALIA S.R.L., Milano (IT)

(21) Appl. No.: 13/060,717

(22) PCT Filed: Sep. 3, 2009
(86) PCT No.: PCT/EP09/61394

§ 371 Date: Feb. 25, 2011

(30) Foreign Application Priority Data
Sep. 8, 2008 (EP) 08163837.1

(51) Int. Cl. B01J 31/02; C08F 4/50

(52) U.S. Cl. 526/111; 502/168

(57) ABSTRACT

A solid catalyst component for polymerizing at least one olefin comprising Mg, Ti, at least one halogen, and at least one electron donor selected from arylsulfonates and arylsulfonyl derivatives of a specified formula

The solid catalyst component is able to give in high yields polyolefins with high stereoregularity.

This application is the U.S. national phase of International Application PCT/EP2009/061394, filed Sep. 3, 2009, claiming priority to European Application 08163837.1 filed Sep. 8, 2008 and the benefit under 35 U.S.C. 119(e) of U.S. Provisional Application No. 61/191,698, filed Sep. 11, 2008; the disclosures of International Application PCT/EP2009/061394, European Application 08163837.1 and U.S. Provisional Application No. 61/191,698, each as filed, are incorporated herein by reference.

### FIELD OF INVENTION

The present inventive subject matter relates to a novel class of catalyst components for polymerizing at least one olefin, catalysts obtained from the novel catalyst components, and processes for polymerizing at least one olefin in presence of at least one of the novel catalyst components. In particular, when the novel class of catalyst components is used in preparing catalysts for polymerizing at least one olefin, the catalysts produce polymers comprising an advantageous balance of properties as compared to previously known catalysts.

### BACKGROUND OF INVENTION

The use of electron donor compounds for preparing polymers, in particular, polyolefins is well known in the art. In addition to using alkyl-aluminum compounds as electron donors, U.S. Pat. No. 4,725,656 to Kashiwa, et al. relates to a process for producing an olefin polymer by using particular classes of ester compounds as electron donor compounds.

Additionally, as with using electron donor compounds for preparing polyolefins, sulfur containing compounds, such as sulfones, are also well known in the general chemical art. For example, U.S. Pat. Nos. 3,125,604, 3,579,590, and 5,015,775 each relate to processes for preparing sulfone compounds.

However, although sulfur containing compounds such as sulfones, and the use of electron donor compounds for polymerizing olefins were each known in their respective arts, the use of sulfur containing compounds as electron donor compounds in catalyst components for the polymerization of at least one polyolefin was previously unknown in the art. In particular, it was previously unknown in the polymer field to use the currently claimed sulfur containing compounds as electron donor compounds in catalyst components for preparing catalysts, in which the catalysts can be used for polymerizing at least one polyolefin. Additionally, there remains a need in the art to discover new and useful classes of electron donor compounds which produce catalysts able to produce olefin polymers in high yields and with a good balance of properties.

### SUMMARY OF THE INVENTION

The present inventive subject matter relates to a novel class of catalyst components for polymerizing at least one olefin, catalysts obtained from the novel catalyst components, and processes for polymerizing at least one olefin in presence of at least one of the novel catalyst components.

In this regard, a preferred embodiment of the present inventive subject matter relates to a solid catalyst component for polymerizing at least one olefin comprising Mg, Ti, at least one halogen, and at least one electron donor of formula (I)

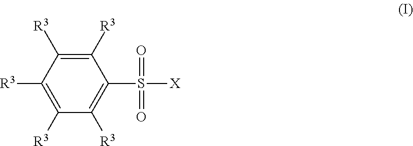

wherein
X is —OR¹, (CR²₂)—COR⁴, —(CR⁵₂)—(CR⁶₂)ₙ—COOR⁷, or R⁸;
R¹ is a C₆-C₁₀ aryl, wherein the C₆-C₁₀ aryl is optionally substituted with at least one substituent selected from hydrogen, halogens, linear or branched C₁-C₁₋₂₀ alkyls,
R² is independently hydrogen or a C₁-C₂₀ alkyl group or a cycloalkyl group;
R³ are each independently the same or different, and are hydrogen, a halogen, a —COOR⁹ group, a linear or branched C₁-C₂₀ alkyl, and a linear or branched C₂-C₂₀ alkylene, wherein the linear or branched C₁-C₂₀ alkyl or C₂-C₂₀ alkylene is optionally substituted with at least one substituent selected from hydrogen, halogens, linear or branched C₁-C₂₀ alkyls, and linear or branched C₂-C₂₀ alkylenes;
R⁴ is a C₃-C₂₀ secondary or tertiary alkyl group or a cycloalkyl group;
R⁵ and R⁶ are each independently the same or different, and are hydrogen, a halogen, a linear or branched C₁-C₂₀ alkyl, and a linear or branched C₂-C₂₀ alkylene, wherein the linear or branched C₁-C₂₀ alkyl or C₂-C₂₀ alkylene is optionally substituted with at least one substituent selected from hydrogen, halogens, linear or branched C₁-C₂₀ alkyls, and linear or branched C₂-C₂₀ alkylenes, with the proviso that the R⁵ groups cannot be simultaneously hydrogen;
R⁷ is a linear or branched C₁-C₂₀ alkyl, a C₆-C₂₀ aryl or alkylaryl and a linear or branched C₂-C₂₀ alkylene, wherein the linear or branched C₁-C₂₀ alkyl or C₂-C₂₀ alkylene is optionally substituted with at least one substituent selected from hydrogen, halogens, linear or branched C₁-C₂₀ alkyls, and linear or branched C₂-C₂₀ alkylenes;
R⁸ and R⁹ are independently a linear or branched C₁-C₂₀ alkyl, a C₆-C₁₀ aryl or a C₃-C₂₀ cycloalkyl group, wherein the C₆-C₁₀ aryl and the C₃-C₂₀ cycloalkyl group is optionally substituted with at least one substituent selected from halogens, linear or branched C₁-C₂₀ alkyls;
n is an integer from 0 to 4;
   with the proviso that when X is OR¹ at least two of R³ groups are different from hydrogen; when X is (CR²₂)—COR⁴ and if both R² are hydrogen or a primary alkyl group, at least one of R³ is different from hydrogen and when X is R⁸ and R⁸ is a linear C₁-C₂₀ alkyl at least one of R³ is different from hydrogen.

Another preferred embodiment of the present inventive subject matter relates to a catalyst for polymerizing at least one olefin comprising the product obtained by reacting:

(a) a solid catalyst component as defined above;

(b) at least one alkylaluminum compound; and

(c) optionally, at least one external electron-donor compound.

Yet even another preferred embodiment of the present inventive subject matter relates to a process for polymerizing at least one olefin comprising contacting:
at least one olefin monomer of formula (III)

CH₂═CHR^{o} (III)
wherein R^{o} is hydrogen, a C₁-C₁₀ alkyl or C₂-C₁₀ alkylene;
with
a catalyst system comprising the product obtained by reacting the component (a), (b) and, optionally (c) as defined above.

### DETAILED DESCRIPTION OF THE INVENTION

A preferred aspect of the present inventive subject matter expressed herein relates to a novel class of catalyst components for polymerizing at least one olefin, catalysts obtained from the novel catalyst components, and processes for polymerizing at least one olefin in presence of at least one of the novel catalyst components. In this regard, the present subject matter relates to a solid catalyst component for polymerizing at least one olefin comprising Mg, Ti, at least one halogen, and at least one electron donor of formula (I)

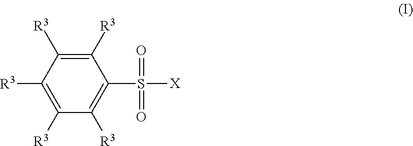

wherein X, R¹-R⁹ and n are as defined above.

In a preferred embodiment, the solid catalyst component comprises at least one electron donor of formula (I), wherein X is selected from —OR¹, —(CR²₂)—COR⁴, —(CR⁵₂)—(CR⁶₂)ₙ—COOR⁷.

When in the compound of formula (I) X is OR¹, the R¹ group is preferably chosen among phenyl groups which are preferably substituted with C₁-C₁₀ hydrocarbon groups, preferably linear or branched C₁-C₅ alkyl groups, still preferably methyl groups. In connection with X being —OR¹, it constitutes a still preferred embodiment having at least three R³ groups different from hydrogen and preferably chosen among C₁-C₁₀ hydrocarbon groups, preferably linear or branched C₁-C₅ alkyl groups, still preferably methyl groups. Exemplary, non-limiting examples of compounds of formula (I) belonging to this class are phenyl 2,4,6-trimethylbenzenesulfonate, 2,6-dimethylphenyl 2,4,6-trimethylbenzenesulfonate.

When in the compound of formula (I) X is —(CR²₂)—COR⁴, at least one of the R² groups is preferably selected among C₃-C₁₀ alkyl groups, preferably among C₃-C₁₀ branched alkyl groups and particularly among C₃-C₁₀ secondary or tertiary alkyl groups. The R⁴ groups are preferably selected among C₄-C₁₀ tertiary alkyl groups. Moreover, the R³ groups different from hydrogen are preferably selected from halogens and C₁-C₁₀ hydrocarbon groups, preferably linear or branched C₁-C₅ alkyl groups; more preferably they are chloride. Exemplary, non-limiting examples of compounds of formula (I) belonging to this class are 1-methyl-2-[(4-chloro-phenyl)-sulfonyl]-ethanone, 1-tert-butyl-2-[(4-chloro-phenyl)-sulfonyl]-ethanone, 2,2-dimethyl-4-(phenylsulfonyl)octan-3-one, 2,2,6-trimethyl-4-(phenylsulfonyl)heptan-3-one, 2,2,5-trimethyl-4-(phenylsulfonyl)hexan-3-one.

When in the compound of formula (I) X is —(CR⁵₂)—(CR⁶₂)ₙ—COOR⁷ n is preferably 0 or 1 and it is most preferably 0. Preferably, at least one of R⁵ is different from hydrogen and selected from linear or branched C₁-C₂₀ alkyls. According to one preferred embodiment, both R⁵ groups are linear C₁-C₈ alkyl groups. According to another preferred embodiment one R⁵ group is hydrogen and the other is selected from branched C₃-C₈ alkyl groups preferably secondary or tertiary. In combination with any of the above preferred embodiments, the R⁷ groups are selected from C₁-C₁₀ hydrocarbon groups, preferably linear or branched C₁-C₅ alkyl groups. Exemplary, non-limiting examples of compounds of formula (I) belonging to this class are ethyl 4-methyl-2-(phenylsulfonyl)pentanoate, ethyl 3-methyl-2-(phenylsulfonyl)butanoate, ethyl 2-(phenylsulfonyl)-2-propylpentanoate.

When in the compound of formula (I) X is R⁸ it is preferably selected from C₆-C₁₀ aryl groups that are preferably susbstituted with one or more substituent selected from halogens, linear or branched C₁-C₂₀ alkyls. Preferably, in connection with R⁸ being as defined above, at least one of the R³ groups is selected from halogens, a —COOR⁹ group, and a linear or branched C₁-C₂₀ alkyl. It is preferred that only one of R³ groups is a —COOR⁹ group, while the other being hydrogen or a C₁-C₂₀ alkyl. Instead, more than one R³ groups, and preferably two or three of them, are C₁-C₂₀ alkyls and preferably C₁-C₅ linear alkyls in particular methyl. Exemplary, non-limiting examples of compounds of formula (I) belonging to this class are di-phenyl sulfone, 2-(mesitylsulfonyl)-1,3,5-trimethylbenzene, 1-(isopropylsulfonyl)benzene, ethyl 2-(methylsulfonyl)benzoate.

In addition to an electron donor of formula (I), the catalyst components of the present inventive subject matter comprise Ti, Mg, and at least one halogen. In particular, preferred embodiments of the catalyst components comprise at least one titanium compound comprising at least one titanium-halogen bond, with the electron donor of formula (I) optionally being supported on active magnesium-halide support. In yet a further particularly preferred embodiment, the active magnesium-halide support is preferably MgCl₂ in an active form, which is exemplified in U.S. Pat. Nos. 4,298,718 and 4,495,338, both of which are incorporated herein by reference in their entirety. As disclosed in the aforementioned patents, active magnesium dihalides are used as a support or co-support for polymerizing olefins, and are characterized by X-ray spectra in which a most intense diffraction line appears in a spectrum of a non-active halide, and is diminished in intensity and is replaced by a halo comprising a maximum intensity displaced towards lower angles relative to that of the more intense line.

In a particularly preferred embodiment, the titanium compound in the catalyst components of the present inventive subject matter is TiCl₄, TiCl₃, or combinations thereof. Additionally, in another particularly preferred embodiment, the titanium compound is at least one titanium-haloalcoholate of formula (II)

Ti(OR¹⁰)_{p-y}Z_{y}, (II)

wherein p is a valence of titanium and y is a number between 1 and p, and R¹⁰ is a linear or branched C₁-C₂₀ alkyl, a C₆-C₂₀ aryl, or a linear or branched C₂-C₂₀ alkylene, wherein the linear or branched C₁-C₂₀ alkyl, the C₆-C₂₀ aryl and the linear or branched C₂-C₂₀ alkylene are optionally substituted with at least one substituent selected from hydrogen, halogen, a linear or branched C₁-C₂₀ alkyl, and a linear or branched C₂-C₂₀ alkylene or more than one R¹⁰ are optionally linked to form a heterocyclic ring optionally comprising at least one heteroatom selected from O, S, N, Si, or combinations thereof. Additionally, in yet another particularly preferred embodiment, the titanium compound of the present subject matter can be a mixture combining at least two titanium compounds, wherein the titanium compounds are selected from TiCl₄, TiCl₃, and at least one titanium-haloalcoholate of formula (II).

The solid catalyst component of the present inventive subject matter can be prepared by many methods

In a preferred method, the magnesium-halide is pre-activated according to well known methods in the art, and is then treated at a temperature of about 80 to about 135° C. with an excess of a solution comprising at least one titanium compound, which in a particular preferred embodiment is TiCl₄, and the electron donor of formula (I) at a temperature of about 80 to 135° C. The treatment with the solution comprising the titanium compound and the electron donor of formula (I) is then repeated, and the resultant product is then washed with an inert hydrocarbon solvent, as defined above, in order to remove any non-reacted titanium compound.

Moreover, in yet another preferred method, the catalyst components of the present subject matter can be produced by a reaction between at least one magnesium alcoholate, magnesium chloroalcoholate, or combinations thereof, such as those prepared according to U.S. Pat. No. 4,220,554, which is incorporated herein by reference in its entirety, and an excess of a solution comprising at least one titanium compound and the electron donor compound of formula (I) at a temperature of about 80 to about 120° C. Even more so, in yet another preferred method, the catalyst components of the present subject matter can be produced by a reaction between TiCl₄, TiCl₃ or a titanium compound of formula (II) as defined above, with magnesium chloride derived from an adduct of formula (IV)

MgCl₂.qR¹¹OH (IV)

wherein q is a number between 0.1 and 6, more preferably from 2 to 3.5, and R¹¹ is a hydrocarbon radical comprising 1-18 carbon atoms. The adduct can be prepared in a spherical form by mixing a R¹¹OH alcohol and magnesium chloride in presence of an inert hydrocarbon immiscible with the adduct, operating under stirring conditions at the melting temperature of the adduct, which in a particularly preferred embodiment ranges from about 100 to about 130° C. to form an emulsion. The emulsion is then quickly quenched, thereby causing the adduct to solidify in the form of spherical particles.

Preferred, exemplary embodiments of spherical adducts prepared according to this procedure are described in U.S. Pat. No. 4,399,054 and U.S. Pat. No. 4,469,648. The adduct obtained by this method can be then be directly reacted with at least one titanium compound, or the adduct can be subjected to thermally controlled dealcoholation at a temperature ranging from about 80 to about 130° C. to obtain an adduct comprising a molar amount of alcohol generally lower than 3, preferably between 0.1 and 2.5. The reaction with the titanium compound can be carried out by suspending the adduct, regardless as to whether the adduct was previously subjected to thermally controlled dealcoholation, in cold TiCl₄ at about 0° C. The mixture comprising the titanium compound, adduct, and TiCl₄ is then heated up to about 80 to about 130° C. for about 0.5 to 2 hours. The treatment with TiCl₄ can be carried out one or more times, and the electron donor can be added during the treatment with TiCl₄. Additionally, electron donor can be added all at once, or in a step-wise fashion.

The preparation of catalyst components in spherical form are described for example in European Patent Applications EP-A-395083, EP-A-553805, EP-A-553806, EPA-601525 and WO98/44001.

The solid catalyst components obtained according to the above exemplary methods comprise a surface area by B.E.T. method generally between 20 and 500 m²/g, and preferably between 50 and 400 m²/g, with the solid catalyst components comprising a total porosity by B.E.T. method higher than 0.2 cm³/g, preferably between 0.2 and 0.6 cm³/g. The porosity by Hg method ranges from 0.3 to 1.5 cm³/g, preferably from 0.45 to 1 cm³/g, due to the catalyst components comprising pores having radii up to about 10,000 Å.

In yet another preferred embodiment, the catalyst components of the present subject matter can be prepared by halogenating at least one magnesium dihydrocarbyloxide compound, such as magnesium dialkoxide, diaryloxide, or combinations thereof, with a solution of TiCl₄ in an aromatic hydrocarbon, such as toluene, xylene, benzene, or mixtures thereof, at temperatures between about 80 to about 130° C. The treatment with TiCl₄ in the aromatic hydrocarbon can be repeated one or more times, and the electron donor of formula (I) is then added during at least one of these treatments.

In any of the preparation methods described above, the electron donor of formula (I) can be added as described, or in an alternative way, such that catalyst components comprising the electron donor can be obtained in situ by using an appropriate precursor capable of being transformed into the desired electron donor by means, for example, of known chemical reactions such as esterification, transesterification, or similar processes. Generally, the electron donor of formula (I) is used in a molar ratio with respect to the magnesium-halide of from 0.01 to 1, preferably from 0.05 to 0.5.

The solid catalyst components of the present inventive subject matter are converted into catalysts for polymerizing at least one olefin by reacting at least one catalyst component with at least a suitable cocatalyst which is preferably chosen among organoaluminum compound.

In particular, the present subject matter relates to a catalyst for polymerizing at least one olefin comprising the product obtained by reacting:

(a) a solid catalyst component comprising Mg, Ti, at least one halogen, and at least one electron donor of formula (I) as defined above, (b) an aluminum alkyl and optionally (c) an external electron donor compound.

In a preferred embodiment, the alkylaluminum compound is selected from trialkylaluminum compounds. Non-limiting examples of trialkylaluminum compounds include, but are not limited to, triethylaluminum, triisobutylaluminum, tri-n-butylaluminum, tri-n-hexylaluminum, tri-n-octylaluminum, and mixtures thereof. Additionally, in another preferred embodiment at least one mixture comprising at least one trialkylaluminum with at least one alkylaluminum halide, alkylaluminum hydride, or alkylaluminum sesquichloride can be used. Particular preferred embodiments include, but are not limited to AlEt₂Cl and Al₂Et₃Cl₃.

Additionally, in another preferred embodiment, the catalyst components can comprise at least one external donor, which can be the same or different from the electron donor of formula (I). Non-limiting examples of preferred external donor compounds, in addition to those discussed previously with respect to formula (I), include silicon compounds, ethers, esters such as ethyl 4-ethoxybenzoate, amines, heterocyclic compounds, such as 2,2,6,6-tetramethyl piperidine, ketones and the 1,3-diethers of the formula (V):

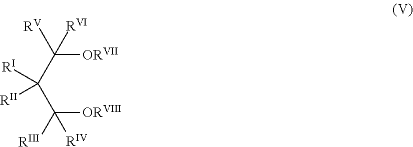

wherein R^{I}, R^{II}, R^{III}, R^{IV}, R^{V} and R^{VI} are equal or different to each other, and are hydrogen or hydrocarbon radicals comprising from 1 to 18 carbon atoms, and R^{VII} and R^{VIII}, are equal or different from each other with the proviso that R^{VII} and R^{VIII} cannot be hydrogen, and wherein one or more of R^{I}-R^{VIII} can be linked to form a cycle. Particularly preferred embodiments include 1,3-diethers, wherein R^{VII} and R^{VIII} are selected from C₁-C₄ alkyl radicals.

Another class of preferred external donor compounds include silicon compounds of formula (VI)

Rₐ¹²R_{b}¹³Si(OR¹⁴)_{c} (VI)

wherein a and b are an integer from 0 to 2, c is an integer from 1 to 4, with the proviso that the sum of (a+b+c) is 4, and R¹², R¹³, and R¹⁴ are independently the same or different, and are a linear or branched C₁-C₁₈ alkyl, C₃-C₁₈ cycloalkyl, or C₃-C₁₈ aryl optionally comprising at least one heteroatom selected from O, N, S, Si, or combinations thereof. Particularly preferred embodiments include silicon compounds in which a is 1, b is 1, c is 2, at least one of R⁶ and R⁷ is selected from a branched C₃-C₁₀ alkyl, C₃-C₁₀ cycloalkyl, or C₃-C₁₀ aryl optionally comprising at least one heteroatom selected from O, N, S, Si, or combinations thereof, and R⁸ is a C₁-C₁₀ alkyl optionally comprising at least one heteroatom selected from O, N, S, Si, or combinations thereof. In another particularly preferred embodiment, R¹⁴ is methyl.

Non-limiting examples of preferred silicon compounds include, but are not limited to methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and combinations thereof.

In yet another preferred embodiment, the external donor compound is at least one silicon compound of formula (VI) in which a is 0, c is 3, R¹³ is a branched alkyl or a cycloalkyl, optionally comprising at least one heteroatom, and R⁸ is methyl. Non-limiting examples of additionally preferred silicon compounds include, but are not limited to, cyclohexyltrimethoxysilane, t-butyltrimethoxysilane, thexyltrimethoxysilane, and combinations thereof.

In a preferred embodiment, the external donor compound is used in an amount suitable to give a molar ratio between the alkylaluminum compound and the external donor of from about 0.1 to about 500, preferably from about 1 to about 300, and more preferably from about 3 to about 100.

As previously indicated, when used in polymerizing at least one olefin, in particular that of propylene, the catalysts of the present subject matter obtain relatively high yields of polymers comprising a high isotactic index expressed by a high xylene insolubility (X.I.). Accordingly, polymers produced using the catalysts of the present subject matter comprise an excellent balance of properties.

Therefore, the present subject matter further relates to a process for polymerizing at least one olefin comprising

contacting at least one olefin monomer of formula (III)

CH₂═CHR^{o} (III)
wherein R^{o} is hydrogen or a C₁-C₁₀ alkyl or a C₂-C₁₀ alkylene;
with—a catalyst system comprising the product obtained by reacting the component (a), (b) and, optionally (c) as defined above.

In a preferred embodiment, the inventive subject matter relates to a process for polymerizing at least one alpha-olefin comprising from 2 to 12 carbon atoms. In a particularly preferred embodiment, the alpha-olefin is selected from ethylene, propylene, 1-butene, 1-hexene, 1-octene, and mixtures thereof. Among the alpha-olefins listed, ethylene, propylene, 1-butene, and mixture thereof are especially preferred.

The polymerization process can be carried out according to known techniques, including but not limited to slurry polymerization processes using an inert hydrocarbon solvent as a diluent, or bulk polymerization processes using a liquid-olefin monomer as a reaction medium. Non-limiting examples of liquid olefin monomers include, but are not limited to ethylene, propylene, 1-butene, 1-hexene, 1-octene, and mixtures thereof. Moreover, in another preferred embodiment, the polymerization process can be carried out in a gas-phase process, in which the gas-phase process comprise one or more fluidized or mechanically agitated bed reactors.

In a preferred embodiment, the polymerization process is generally carried out at temperature of from about 20 to about 120° C., and in a particularly preferred embodiment, the polymerization process is generally carried out at a temperature of from about 40 to about 80° C.

In another particularly preferred embodiment, when the polymerization process is carried out in a gas-phase process, the operating pressure is generally between about 0.5 to about 10 MPa, preferably between about 1 to about 5 MPa. In another particularly preferred embodiment, when the polymerization process is carried out in a bulk polymerization process, the operating pressure is generally between about 1 to 6 MPa, more preferably between 1.5 and 4 MPa. Hydrogen or other compounds capable to act as chain transfer agents may be used in the polymerization process to control the molecular weight of polymer produced.

As it results from the polymerization examples described below, the catalyst systems based on the catalyst components containing the internal donors of formula I are able to offer satisfactory activity/stereospecificity balance combined with a wide range of hydrogen response which is confirmed by the values of the Melt Flow Rates (determined according to ISO 1133, 230° C., 2.16 Kg) ranging from 1 to 50 g/10 min always using the same hydrogen amount as a molecular weight regulator. Evidence of the good hydrogen response is given by the fact that in many instances the MFR values result to be higher than 5 and preferably higher than 10 g/10 min.

The following examples are illustrative of preferred compositions and are not intended to be limitations thereon. All polymer molecular weights are mean average molecular weights. All percentages are based on the percent by weight of the final catalyst component or polymer prepared unless otherwise indicated, and all totals equal 100% by weight.

Procedures:

### Determination of X.I.

2.5 g of polymer were dissolved in 250 ml of o-xylene under stirring at 135° C. for 30 minutes, then the solution was cooled to 25° C. and after 30 minutes the insoluble polymer was filtered. The resulting solution was evaporated in nitrogen flow and the residue was dried and weighed to determine the percentage of soluble polymer and then, by difference the xylene insoluble fraction (%).

### Propylene Polymerization: General Procedure

A 4-liter autoclave was purged with nitrogen flow at 70° C. for one our and then charged at 30° C. under propylene flow with 75 ml of anhydrous hexane, 760 mg of AlEt₃, 76.0 mg of dicyclopentyldimethoxysilane and 10 mg of a solid catalyst component. The autoclave was closed. Subsequently, 2.0 Nl of hydrogen were added (in the polymerization runs of Ex. 3 and comparative Ex. 1, were added 1.5 Nl of hydrogen). Then, under stirring, 1.2 Kg of liquid propylene was fed. The temperature was raised to 70° C. in five minutes and the polymerization was carried out at this temperature for two hours. The non-reacted propylene was removed; the polymer was recovered and dried at 70° C. under vacuum for three hours.

Melt Index: Determined according to ISO 1133 (230° C., 2.16 Kg)

Polydispersity Index (P.I.)

Determined at a temperature of 200° C. by using a parallel plates rheometer model RMS-800 marketed by RHEOMETRICS (USA), operating at an oscillation frequency which increases from 0.1 rad/sec to 100 rad/sec. The value of the polydispersity index is derived from the crossover modulus by way of the equation: P.I.=10⁵/Gc
in which Gc is the crossover modulus defined as the value (expressed in Pa) at which G′=G″ wherein G′ is the storage modulus and G″ is the loss modulus.

Poured bulk density: determined according to DM-53194

Electron Donor Compounds:

### Example 1

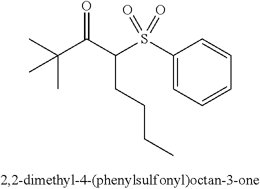

Step 1

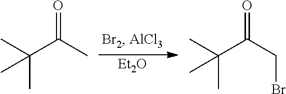

To a cooled water bath solution, 50 g (500 mmol) of 3,3-dimethyl-2-butanone in 400 ml of absolute Et₂O was added by dropwise addition to 1.0 g of AlCl₃ and 25.7 ml (500 mmol) of bromine. When the solution became colorless, it was poured into 600 ml of water, and extracted by Et₂O (3*100 ml). The combined organic phase was washed by aqueous KHCO₃, water, and dried over MgSO₄. The resulting solution was evaporated and distilled (B.p. 70-72° C./10 Torr), yielding 71.6 g (80%) of 1-bromo-3,3-dimethyl-2-butanone. H¹NMR (CDCl₃, δ, 25° C.): 4.20 (s, 2H, CH₂), 1.23 (s, 9H, t-Bu). C¹³NMR (CDCl₃, δ, 25° C.): 205.84, 43.98, 31.72, 26.49.

Step 2

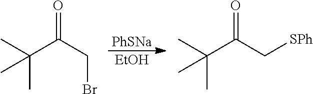

To a solution of NaOEt, which was prepared from 5.2 g (226 mmol) of Na in 150 ml of absolute ethanol, 25.3 g (230 mmol) of thiophenol was added. The reaction mixture was stirred for 30 minutes and treated with 40.0 g (223 mmol) of 1-bromo-3,3-dimethyl-2-butanone from Step 1. Stirring was continued overnight for 16 h. The reaction mixture was then poured into 600 ml of water, and extracted by hexane (3*100 ml). The combined organic phase was washed by water and dried over MgSO₄. The resulting solution was evaporated and distilled (B.p. 96° C./0.6 Torr), yielding 34.8 g (75%) of 3,3-dimethyl-1-(phenylsulfanyl)-2-butanone. H¹NMR (CDCl₃, δ, 25° C.): 7.41 (d, 2H, Ph), 7.32 (d, 2H, Ph), 7.24 (d, 1H, Ph), 4.00 (s, 2H, CH₂), 1.22 (s, 9H, (CH₃)₃). C¹³NMR (CDCl₃, δ, 25° C.): 209.24, 135.29, 129.89, 128.75, 126.50, 44.07, 40.38, 26.39.

Step 3

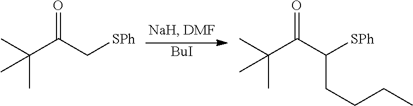

To a stirred and cooled water bath suspension of 2.6 g (65 mmol) of NaH (60% suspension in paraffin oil) in 100 ml of dry DMF, 13 g (62 mmol) of a solution of 3,3-dimethyl-1-(phenylsulfanyl)-2-butanone, from Step 2, in 35 ml of DMF was added dropwise. After the hydrogen was isolated, the mixture was stirred for an additional 15 minutes. 13 g (70 mmol) of 1-iodobutane was then added dropwise, after which, cooling was removed and the mixture was stirred overnight for 16 h at room temperature. The reaction mixture was then poured into 500 ml of water, and extracted by hexane (4*100 ml). The combined organic phase was washed by water (3*100 ml) and dried over MgSO₄. The resulting solution was evaporated and distilled (B.p. 115-118° C./0.2 Torr), yielding 9.8 g (60%) of 2,2-dimethyl-4-(phenylsulfanyl)-3-octanone. H¹NMR (CDCl₃, δ, 25° C.): 7.44 (m, 2H, Ph), 7.34 (m, 3H, Ph), 4.02 (dd, 1H, CH), 1.87 (m, 1H, CH₂), 1.69 (m, 1H, CH₂), 1.35 (m, 4H, CH₂), 1.21 (s, 9H, (CH₃)₃), 0.93 (t, 3H, CH₃). C¹³NMR (CDCl₃, δ, 25° C.): 210.98, 133.88, 132.73, 128.73, 128.09, 49.76, 43.98, 34.49, 26.75, 20.68, 13.80.

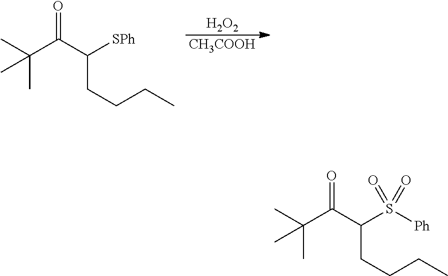

Step 4

To a stirred and cooled ice bath solution, 9.8 g (37 mmol) of 2,2-dimethyl-4-(phenylsulfanyl)-3-octanone in 150 ml of acetic acid was added dropwise to 10 ml g (115 mmol) of 35% H₂O₂. The solution was stirred overnight for 16 h at room temperature, and then evaporated, with the residue then dissolved in 40 ml of CHCl₃, and flashchromatographed (CHCl₃, silica gel 60-200, Rf˜0.40), yielding 8.9 g (81%) of 2,2-dimethyl-4-(phenylsulfonyl)-3-octanone. H¹NMR (CDCl₃, δ, 25° C.): 7.82 (d, 2H, Ph), 7.71 (t, 1H, Ph), 7.58 (t, 2H, Ph), 4.63 (dd, 1H, CH), 1.86 (m, 1H, CH₂), 1.75 (m, 1H, CH₂), 1.26 (m, 4H, CH₂), 1.21 (s, 9H, (CH₃)₃), 0.85 (t, 3H, CH₃). C¹³NMR (CDCl₃, δ, 25° C.): 208.64, 136.82, 134.01, 129.88, 128.70, 69.19, 45.41, 29.64, 29.18, 26.53, 22.39, 13.52.

### Example 2

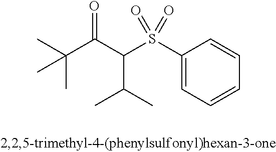

Step 1

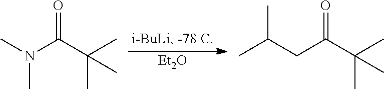

To a solution of 20.0 g (155 mmol) of N,N-dimethyl pyvaloylamide in 100 ml of dry Et₂O, 97 ml (155 mmol) of 1.6 N i-BuLi was added dropwise under stirring and cooling at −78° C. in an argon atmosphere. Cooling was removed, and the mixture was stirred for 2 hours. The mixture was then poured into 500 ml of 5% solution of hydrochloric acid, and extracted by hexane (3*100 ml). The combined organic phase was washed by water (2*200 ml) and dried over MgSO₄. The resulting solution was evaporated. The product was distilled, yielding 17.0 g (77%) of 2,2,5-trimethyl-3-hexanone. Hⁱ NMR (CDCl₃, δ, 25° C.): 2.35 (d, 2H, COCH₂), 2.20 (m, 1H, CH), 1.13 (s, 9H, t-Bu), 0.89 (d, 6H, CH₃). C¹³ NMR (CDCl₃, δ, 25° C.): 215.28, 45.29, 43.92, 26.08, 23.80, 22.42.

Step 2

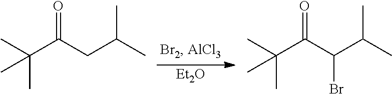

To a cooled water bath solution, 17.0 g (119 mmol) of 2,2,5-trimethyl-3-hexanone in 200 ml of absolute Et₂O was added to 0.4 g of AlCl₃ and 6.2 ml (119 mmol) of bromine by dropwise addition. When the solution became colorless, it was poured into 600 ml of water, and extracted by Et₂O (3*100 ml). The combined organic phase was washed by aqueous KHCO₃, water, and dried over MgSO₄. The resulting solution was evaporated and distilled (B.p. 100-102° C./10 Torr), yielding 21.0 g (80%) of 4-bromo-2,2,5-trimethyl-3-hexanone. H¹ NMR (CDCl₃, δ, 25° C.): 4.37 (d, 1H, COCH), 2.31 (m, 1H, CH), 1.26 (s, 9H, t-Bu), 1.18 (d, 3H, CH₃), 0.93 (d, 3H, CH₃). C¹³ NMR (CDCl₃, δ, 25° C.): 208.99, 53.21, 44.26, 31.15, 26.84, 20.63, 20.18.

Step 3

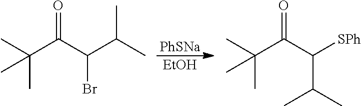

To a solution of NaOEt, prepared from 2.3 g (100 mmol) of Na in 150 ml of absolute ethanol, 11.55 g (105 mmol) of thiophenol was added. The reaction mixture was stirred for 30 minutes, and then treated with 21.0 g (95 mmol) of 4-bromo-2,2,5-trimethyl-3-hexanone from Step 2. Stirring was continued overnight for 16 h. The reaction mixture was then poured into 600 ml of water, and extracted by hexane (3*100 ml). The combined organic phase was washed by water and dried over MgSO₄. The resulting solution was evaporated and distilled (B.p. 106° C./0.2 Torr), yielding 20.2 g (85%) of 2,2,5-trimethyl-4-(phenylsulfanyl)-3-hexanone. H¹NMR (CDCl₃, δ, 25° C.): 7.43 (m, 2H, Ph), 7.33 (m, 3H, Ph), 3.72 (d, 1H, CH), 2.14 (m, 1H, CH), 1.26 (d, 3H, CH₃), 1.23 (s, 9H, (CH₃)₃), 0.95 (d, 3H, CH₃). C¹³NMR (CDCl₃, δ, 25° C.): 210.03, 133.27, 132.99, 128.61, 127.78, 57.10, 43.75, 29.14, 26.96, 21.09, 19.94.

Step 4

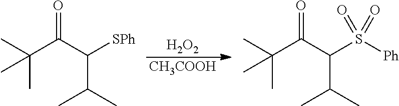

To a stirred and cooled ice bath solution of 20.0 g (80 mmol) of 2,2,5-trimethyl-4-(phenylsulfanyl)-3-hexanone, from Step 3, in 150 ml of acetic acid, 31 ml g (320 mmol) of 35% H₂O₂ was added dropwise. The mixture was stirred overnight for 16 h at room temperature, and was then evaporated. The residue was then dissolved in 40 ml of CHCl₃, and flashchromatographed (CHCl₃, silica gel 60-200, Rf˜0.40), yielding 19.2 g (85%) of 2,2,5-trimethyl-4-(phenylsulfonyl)-3-hexanone. H¹NMR (CDCl₃, δ, 25° C.): 7.87 (d, 2H, Ph), 7.68 (t, 1H, Ph), 7.58 (t, 2H, Ph), 4.49 (d, 1H, CH), 2.15 (m, 1H, CH), 1.22 (d, 3H, CH₃), 1.21 (s, 9H, (CH₃)₃), 0.85 (d, 3H, CH₃). C¹³NMR (CDCl₃, δ, 25° C.): 209.28, 137.67, 133.83, 129.73, 128.57, 75.52, 45.38, 29.33, 26.82, 21.25, 21.06.

### Comparison Example 1

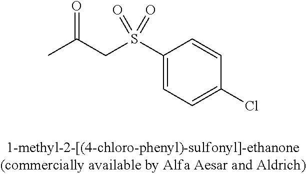

### Example 3

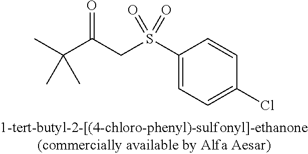

### Example 4

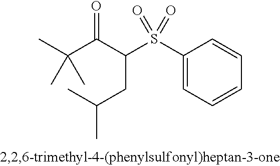

Step 1 and Step 2 needed for the preparation of 2,2,6-trimethyl-4-(phenylsulfonyl)heptan-3-one are reported above within the description of Example 1.

Step 3

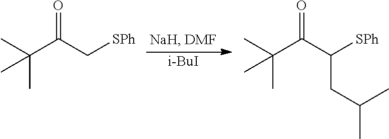

To a stirred and cooled with water bath suspension of 2.6 g (65 mmol) of NaH (60% suspension in paraffin oil) in 100 ml of dry DMF was added dropwise a solution of 13 g (62 mmol) of 3,3-dimethyl-1-(phenylsulfanyl)-2-butanone, from Step 2, in 35 ml of DMF. When the hydrogen was isolated completely, the mixture was stirred for 15 min. Then 13 g (70 mmol) of 1-iodo-2-methylpropane was added dropwise. Cooling was removed and the mixture was stirred overnight for 16 h at room temperature. Then the reaction mixture was poured into 500 ml of water, and extracted by hexane (4*100 ml). The combined organic phase was washed by water (3*100 ml) and dried over MgSO₄. The resulting solution was evaporated and distilled (B.p. 113-116° C./0.2 Torr), yielding 10.6 g (65%) of 2,2,6-trimethyl-4-(phenylsulfanyl)-3-heptanone. H¹NMR (CDCl₃, δ, 25° C.): 7.42 (m, 2H, Ph), 7.34 (m, 3H, Ph), 4.12 (t, 1H, CH), 1.70 (m, 2H, CH₂), 1.57 (m, 1H, CH), 1.20 (s, 9H, (CH₃)₃), 0.93 (d, 6H, CH₃). C¹³NMR (CDCl₃, δ, 25° C.): 211.06, 134.20, 132.51, 128.80, 128.27, 48.24, 44.10, 41.14, 28.48, 26.95, 25.68, 22.57, 22.43.

Step 4

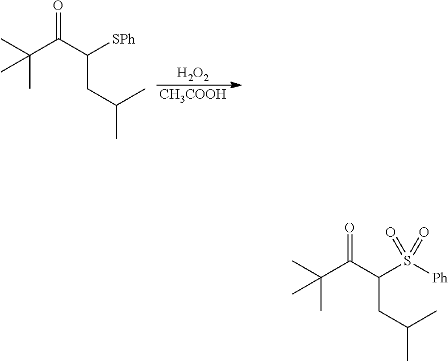

To the stirred and cooled with ice bath solution of 10.6 g (40 mmol) of 2,2,6-trimethyl-4-(phenylsulfanyl)-3-heptanone in 150 ml of acetic acid was added dropwise 14 ml g (160 mmol) of 35% H₂O₂. The reaction mixture was stirred overnight for 16 h at room temperature, then evaporated, the residue was dissolved in 40 ml of CHCl₃ and flashchromatographed (CHCl₃, silica gel 60-200, Rf˜0.40), yielding 9.55 g (80%) of 2,2,6-trimethyl-4-(phenylsulfonyl)-3-heptanone. H¹NMR (CDCl₃, δ, 25° C.): 7.81 (d, 2H, Ph), 7.70 (t, 1H, Ph), 7.58 (t, 2H, Ph), 4.75 (dd, 1H, CH), 1.66 (m, 2H, CH₂), 1.55 (m, 1H, CH), 1.24 (s, 9H, (CH₃)₃), 0.89 (d, 6H, CH₃). C¹³NMR (CDCl₃, δ, 25° C.): 208.68, 136.60, 133.91, 129.79, 129.58, 67.49, 45.35, 38.60, 26.60, 25.21, 22, 76, 21.68.

### Example 5

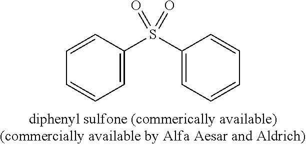

### Example 6

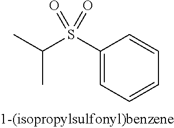

Step 1

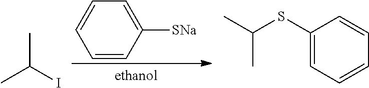

To a solution of NaOEt prepared from 5.2 g (226 mmol) of Na in 150 ml of absolute ethanol, 25.3 g (230 mmol) of thiophenol was added. The reaction mixture was stirred for 30 minutes, and treated with 38.4 g (226 mmol) of isopropyl iodide. Stirring was continued overnight for 16 h. The reaction mixture was then poured into 600 ml of water, and extracted by Et₂O (3*100 ml). The combined organic phase was washed by aqueous KHCO₃, water, and dried over MgSO₄. The resulting solution was evaporated and distilled (B.p. 84° C./10 Torr), yielding 30 g (87%) of (isopropylsulfanyl)benzene.

Step 2

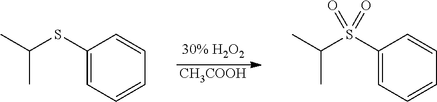

To a stirred and cooled ice bath solution, 30.0 g (197 mmol) of (isopropylsulfanyl)benzene, from Step 1, in 150 ml of acetic acid was added dropwise to 100 ml g (880 mmol) of 30% H₂O₂. The mixture was stirred for 3 days with periodical NMR testing, evaporated, and then distilled (B.p. 108-110° C./0.6 Torr), yielding 32.7 g (90%) of 1-(isopropylsulfonyl)benzene. H¹NMR (CDCl₃, δ, 25° C.): 7.80 (d, 2H, Ph), 7.60 (t, 1H, Ph), 7.47 (t, 2H, Ph), 3.15 (m, 1H, CH), 1.20 (d, 6H, (CH₃)₂). C¹³NMR (CDCl₃, δ, 25° C.): 136.77; 133.49; 128.91; 128.77; 55.28; 15.46.

### Example 7

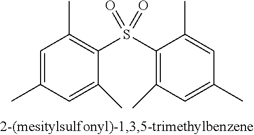

Step 1

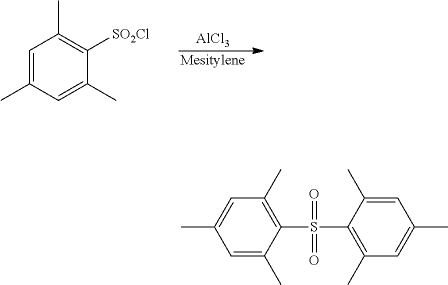

A mixture 10.0 g (46 mmol) of mesitylsulfonyl chloride, 50 ml of mesitylene, and 15.2 g (114 mmol) of AlCl₃ was stirred for 4 hours at room temperature. The mixture was then poured into 600 ml of 5% HCl, and extracted by Et₂O (3*100 ml). The combined organic phase was washed by aqueous KHCO₃, water, and dried over MgSO₄. The resulting solution was evaporated, and the residue was dissolved in 40 ml of CHCl₃, and flashchromatographed (CHCl₃, silica gel 60-200), yielding 8.95 g (64%) of 2-(mesitylsulfonyl)-1,3,5-trimethylbenzene. H¹NMR (CDCl₃, δ, 25° C.): 6.91 (s, 4H, Ph), 2.46 (s, 12H, CH₃), 2.31 (s, 6H, CH₃). C¹³NMR (CDCl₃, δ, 25° C.): 142.15, 138.33, 137.83, 131.85, 21.51, 20.84.

### Example 8

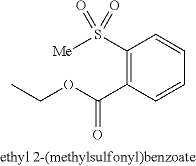

Step 1

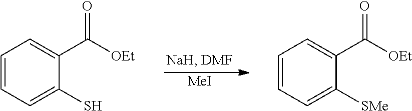

To a stirred and cooled water bath suspension, 2.60 g (65 mmol) of NaH (60% suspension in paraffin oil) in 100 ml of dry DMF was added dropwise to a solution of 10.70 g (59 mmol) of ethyl 2-sulfanylbenzoate in 35 ml of DMF. After the hydrogen evolution was completed, the mixture was stirred for an additional 15 minutes. 9.90 g (70 mmol) of iodomethane was then added dropwise. After the iodomethane was added, cooling was removed and the mixture was stirred for 2 hours at room temperature. The reaction mixture was then poured into 500 ml of water, and extracted by hexane (4*100). The combined organic phase was washed by water (3*100 ml) and dried over MgSO₄. The resulting solution was evaporated and distilled (B.p. 100-103° C./1,0 Torr), yielding 11.23 g (97%) of ethyl 2-(methylsulfanyl)benzoate. H¹NMR (CDCl₃, δ, 25° C.): 8.00 (d, 1H, Ph), 7.46 (t, 1H, Ph), 7.26 (d, 1H, Ph), 7.14 (d, 1H, Ph), 4.38 (q, 2H, OEt), 2.44 (s, 3H, SMe), 1.40 (t, 3H, OEt).

Step 2

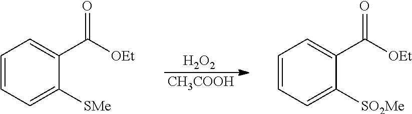

To a stirred and cooled ice bath solution, 11.23 g (57 mmol) of ethyl 2-(methylsulfanyl)benzoate in 150 ml of acetic acid was added dropwise to 21 ml g (230 mmol) of 35% H₂O₂. The mixture was stirred for 3 days at room temperature, evaporated, and the residue was dissolved in 40 ml of CHCl₃, and flashchromatographed (CHCl₃, silica gel 60-200, Rf˜0.40), yielding 11.70 g (90%) of ethyl 2-(methylsulfonyl)benzoate. H¹NMR (CDCl₃, δ, 25° C.): 8.13 (d, 1H, Ph), 7.74-7.65 (m, 3H, Ph), 4.46 (q, 2H, OEt), 3.37 (s, 3H, SMe), 1.43 (t, 3H, OEt). C¹³NMR (CDCl₃, δ, 25° C.): 166.96, 138.75, 133.40, 133.21, 130.97, 129.62, 129.46, 62.34, 44.80, 13.83.

### Example 9

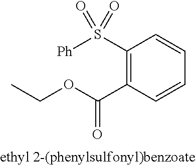

Step 1

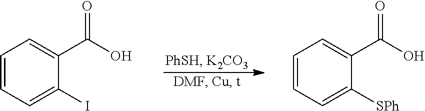

The stirred suspension of 24.80 g (100 mmol) of 2-iodobenzoic acid, 16.50 g (150 mmol) of thiophenol, 41.40 g (300 mmol) of dry K₂CO₃ and 1.5 g of Cu dust in 200 ml of dry DMF was refluxed for 5 hours. Then the mixture was poured into 500 ml of water, the precipitate was filtered, the filtrate was washed with Et₂O:hexane=1:1, treated with 36% HCl up to pH=1 and extracted by Et₂O (4*100 ml). The Et₂O solution was dried over MgSO₄ and evaporated, yielding 19.55 g (85%) of 2-(phenylsulfanyl)benzoic acid. H¹NMR (DMSO-d6, δ, 25° C.): 7.91 (d, 1H, Ph), 7.56-7.39 (m, 5H, SPh), 7.31 (t, 1H, Ph), 7.17 (t, 1H, Ph), 6.70 (d, 1H, Ph).

Step 2

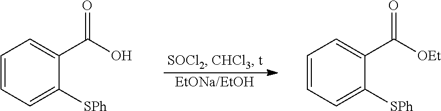

8.1 ml (0.110 mol) of SOCl₂ and 0.1 ml of DMF was added to a suspension of 19.55 g (0.085 mol) of 2-(phenylsulfanyl)benzoic acid in 100 ml of CHCl₃. The obtained mixture was refluxed for 1.5 h. Then solvent was removed. The residue was dissolved in 50 ml of EtOH and treated with a solution obtained by dissolving 2.3 g (0.100 mol) of Na in 100 ml of EtOH. After 1 h of stirring the mixture was poured into 400 ml of water and extracted by hexane (3*150 ml). The combined organic phase was washed by water and dried over MgSO₄. The resulting solution was evaporated giving 19.8 g (90%) of ethyl 2-(phenylsulfanyl)benzoate. H¹ NMR (CDCl₃, δ, 25° C.): 8.04 (d, 1H, Ph), 7.61 (m, 2H, Ph), 7.47 (m, 3H, Ph), 7.27 (t, 1H, Ph), 7.16 (t, 1H, Ph), 6.87 (d, 1H, Ph), 4.48 (q, 2H, OCH₂CH₃), 1.48 (t, 3H, OCH₂CH₃). C¹³ NMR (CDCl₃, δ, 25° C.): 166.24, 142.80, 135.27, 132.40, 131.97, 130.72, 129.49, 128.82, 127.19, 126.88, 124.06, 61.02, 14.12.

Step 3

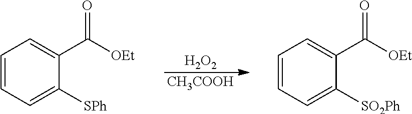

To the stirred and cooled with ice bath solution of 19.80 g (77 mmol) of ethyl 2-(phenylsulfanyl)benzoate in 150 ml of acetic acid was added dropwise 30 ml g (307 mmol) of 35% H₂O₂. Then the reaction mixture was stirred for 3 days at room temperature and evaporated; the residue was dissolved in 40 ml of CHCl₃ and flashchromatographed (CHCl₃, silica gel 60-200, Rf˜0.40), yielding 20.29 g (90%) of ethyl 2-(phenylsulfonyl)benzoate. H¹ NMR (CDCl₃, δ, 25° C.): 8.17 (d, 1H, Ph), 8.03 (d, 2H, Ph), 7.67-7.52 (m, 6H, Ph), 4.47 (q, 2H, OCH₂CH₃), 1.40 (t, 3H, OCH₂CH₃). C¹³ NMR (CDCl₃, δ, 25° C.): 167.03, 141.25, 138.47, 133.41, 133.09, 133.02, 130.52, 129.90, 128.84, 128.73, 127.57, 62.09, 13.75.

### Example 10

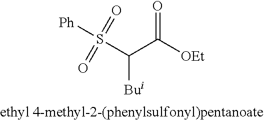

### Example 11

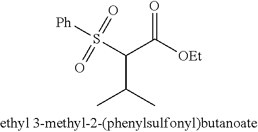

### Example 12

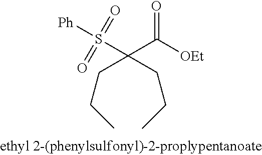

The compounds reported in Examples 10, 11, and 12 were synthesized following the same procedure, as reported below.

Step 1

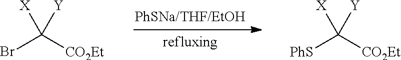

To a solution of sodium ethylate (150 mmol, 1.5 mol eq.) in 100 ml of ethanol was added a solution of thiophenol (150 mmol, 1.5 mol eq.) in 50 ml of THF and refluxed additionally 30 min. The reaction mixture was treated by solution of α(α′)-(di)substituted 2-bromoacetate (100 mmol, 1 mol. eq.) in 100 ml of THF and refluxed additionally while in GC-probe disappeared peak of α(α′)-(di)substituted 2-bromoacetate. The final suspension was diluted in 300 ml of water, organic layer was collected, water phase was extracted by 3*100 ml of hexane, and organic phases were washed to the neutral pH and dried over MgSO₄. Solvent was removed and residue was distillated in vacuo.

Yields and NMR characterization of intermediates coming from Step 1 are reported in the following table.

| Ex. | | | Yield | H¹ NMR | C¹³ NMR |
|---|---|---|---|---|---|
| N° | X | Y | % | (CDCl₃, δ, 20° C.) | (CDCl₃, δ, 20° C.) |
| 10 | i-Bu | H | 75 | 7.46 (t, 2H); 7.29 (m, 3H); | 172.48; 133.51; 132.77; |
| | | | | 4.11 (t, 2H); 3.74 (m, 1H); | 128.83; 127.79; 60.94; |
| | | | | 1.79 (m, 2H); 1.65 (m, 1H); | 49.07; 40.37; 26.08; 22.36; |
| | | | | 1.16 (t, 3H); 0.94 (t, 6H). | 22.13; 14.01. |
| 11 | i-Pr | H | 76 | 7.49 (d, 2H); 7.32 (m, 3H); | — |
| | | | | 4.15 (t, 2H); 3.48 (d, 1H); | |
| | | | | 2.16 (m, 1H); 1.20 (d, 6H); | |
| | | | | 1.08 (t, 3H). | |
| 12 | n-Pr | n-Pr | 50.5 | 7.60-7.30 (m, 5H); 4.18 (t, | 173.04; 136.67; 130.95; |
| | | | | 2H); 1.85-1.75 (m, 2H); | 128.99; 128.88; 128.39; |
| | | | | 1.72-1.63 (m, 2H); 1.60- | 127.30; 126.97; 60.69; |
| | | | | 1.50 (m, 2H); 1.42-1.33 | 59.39; 35.49; 17.33; 14.08; |
| | | | | (m, 2H); 1.26 (t, 3H); 0.97 | 13.93. |
| | | | | (t, 6H). | |

Step 2

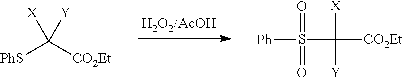

To the solution of α(α′)-(di)substituted benzenesulfonyl-acetic acid ethyl ester (100 mmol, 1 mol. eq.) in 100 ml of glacial acetic acid was added H₂O₂ (400 mmol, 4 mol eq.). The reaction mixture was stirred at room temperature additionally 20 h while in GC-probe disappeared pike of α(α′)-(di)substituted phenylsulfanyl-acetic acid ethyl ester. The solvent was removed in vacuo, the residue was dissolved in 200 ml hexane and washed by a saturated solution of K₂CO₃, dried over MgSO₄. The residue was pure product with appropriate purity.

Yields and NMR characterization of compounds reported in Examples 10, 11, and 12 are reported in the following table.

| Ex. | | | Yield | H¹ NMR | C¹³ NMR |
|---|---|---|---|---|---|
| N° | X | Y | % | (CDCl₃, δ, 20° C.) | (CDCl₃, δ, 20° C.) |
| 10 | i-Bu | H | 71 | 7.90 (d, 2H); 7.70 (t, 1H); | 166.05; 137.04; 134.11; |
| | | | | 7.58 (t, 2H); 4.10 (m, 2H); | 129.24; 128.89; 69.44; |
| | | | | 4.01 (dd, 1H); 1.96 (td, 1H); | 62.03; 34.94; 26.10; 22.79; |
| | | | | 1.83 (m, 1H); 1.58 (m, 1H); | 21.18; 13.73. |
| | | | | 1.14 (t, 3H); 0.91 (t, 6H). | |
| 11 | i-Pr | H | 59 | 7.91 (d, 2H); 7.67 (t, 1H); | 165.84; 138.28; 129.09; |
| | | | | 7.56 (t, 2H); 4.00 (m, 2H); | 128.86; 76.85; 61.70; |
| | | | | 3.81 (d, 1H); 2.55 (m, 1H); | 28.03; 21.19; 20.22; 13.69. |
| | | | | 1.27 (d, 3H); 1.08 (t, 3H); | |
| | | | | 0.97 (t, 3H). | |
| 12 | n-Pr | n-Pr | 64.5 | 7.85 (d, 2H); 7.69 (t, 1H); | 168.06; 136.67; 133.79; |
| | | | | 7.57 (t, 2H); 4.08 (q, 2H); | 130.02; 128.45; 61.85; |
| | | | | 2.15 (m, 2H); 1.96 (m, 2H); | 32.06; 17.46; 14.41; 13.61. |
| | | | | 1.62 (m, 2H); 1.33 (m, 2H); | |
| | | | | 1.17 (t, 3H); 0.97 (t, 6H). | |

### Example 13

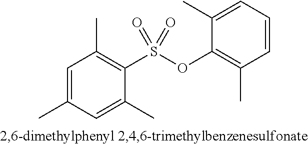

Step 1

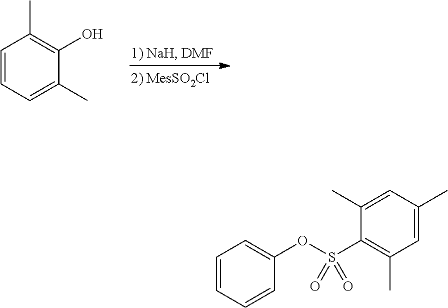

To a stirred and cooled water bath suspension, 2.6 g (65 mmol) of NaH (60% suspension in paraffin oil) in 70 ml of dry DMF was added dropwise to a solution of 7.33 g (60 mmol) of 2,6-dimethylphenol in 35 ml of DMF. After the hydrogen was isolated, the mixture was stirred for an additional 15 minutes. A solution of 12.0 g (55 mmol) of in ml of DMF was then added dropwise. After the solution of 2-mesitylenesulfonylchloride was completely added, cooling was removed and the mixture was stirred overnight for 16 h at room temperature. The reaction mixture was then poured into 500 ml of water, and extracted by CHCl₃ (4*100 ml). The combined organic phase was washed by water (3*100 ml) and dried over MgSO₄. The resulting solution was evaporated, and the residue was washed with hexane yielding 14.71 g (88%) of 2,6-dimethylphenyl 2,4,6-trimethylbenzenesulfonate. H¹NMR (CDCl₃, δ, 25° C.): 7.06 (m, 5H, Ph), 2.69 (s, 6H, CH₃), 2.38 (s, 3H, CH₃), 2.15 (s, 6H, CH₃). C¹³NMR (CDCl₃, δ, 25° C.): 147.97, 143.28, 139.29, 133.63, 132.11, 131.71, 129.02, 126.46, 22.74, 21.02, 17.14.

### Example 14

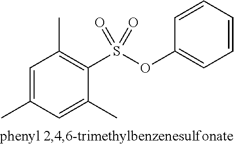

Step 1

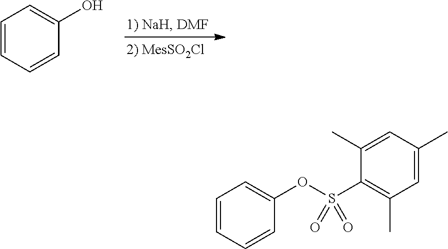

To a stirred and cooled water bath suspension, 2.7 g (67 mmol) of NaH (60% suspension in paraffin oil) in 70 ml of dry DMF was added dropwise to a solution of 6.11 g (65 mmol) of phenol in 35 ml of DMF. After the hydrogen was isolated, the mixture was stirred for an additional 15 minutes. A solution of 13.5 g (62 mmol) of 2-mesitylenesulfonylchloride in 20 ml of DMF was then added dropwise. After the solution of 2-mesitylenesulfonylchloride was completely added, cooling was removed and the mixture was stirred overnight for 16 h at room temperature. The reaction mixture was then poured into 500 ml of water, and extracted by CHCl₃ (4*100 ml). The combined organic phase was washed by water (3*100 ml) and dried over MgSO₄. The resulting solution was evaporated and the residue was washed with hexane, yielding 13.53 g (79%) of phenyl 2,4,6-trimethylbenzenesulfonate. H¹NMR (CDCl₃, δ, 25° C.): 7.29 (m, 3H, Ph), 6.99 (m, 4H, Ph), 2.58 (s, 6H, CH₃), 2.35 (s, 3H, CH₃). C¹³NMR (CDCl₃, δ, 25° C.): 149.36, 143.78, 140.34, 131.68, 130.36, 129.49, 126.91, 122.18, 22.65, 21.02.

### Comparison Example 2

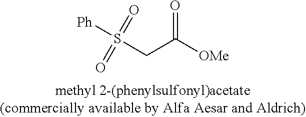

### Comparison Example 3

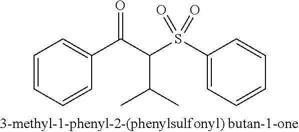

Step 1

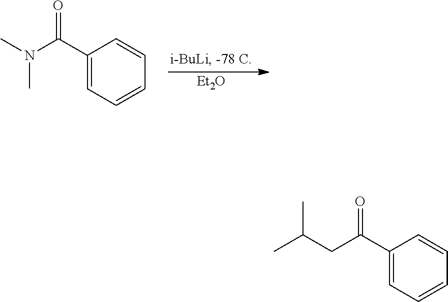

To the solution of 15.0 g (100 mmol) of N,N-dimethylbenzamide in 100 ml of dry Et₂O was added dropwise 48 ml (100 mmol) of 2.1 N i-BuLi under stirring and cooling at −78 C in argon atmosphere. The cooling was removed and the mixture was stirred for 2 h. Then it was poured into 500 ml of 5% solution of hydrochloric acid, extracted by hexane (3*100 ml). The combined organic phase was washed by water (2*200 ml) and dried over MgSO₄. The resulting solution was evaporated. The product was distilled (B.p. 106° C./10 Torr), yielding 14.0 g (86%) of 3-methyl-1-phenyl-1-butanone.

Step 2

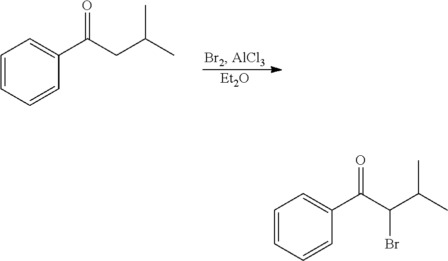

To the cooled with water bath solution of 14.0 g (86 mmol) of 3-methyl-1-phenyl-1-butanone in 200 ml of absolute Et₂O was added 0.4 g of AlCl₃ and 4.5 ml (86 mmol) of bromine by dropwise. When the solution became colorless (2 h), it was poured into 600 ml of water and extracted by Et₂O (3*100 ml). The combined organic phase was washed by aqueous KHCO₃, water, and dried over MgSO₄. The resulting solution was evaporated and distilled (B.p. 135-140° C./10 Torr), yielding 20.1 g (96.5%) of 2-bromo-3-methyl-1-phenyl-1-butanone. H¹ NMR (CDCl₃, δ, 25° C.): 8.03 (d, 2H, Ph), 7.63 (t, 1H, Ph), 7.52 (t, 2H, Ph), 5.00 (d, 1H, COCH), 2.52 (m, 1H, CH), 1.25 (d, 3H, CH₃), 1.07 (d, 3H, CH₃). C¹³ NMR (CDCl₃, δ, 25° C.): 193.53, 134.91, 133.52, 130.49, 128.71, 55.80, 30.97, 20.60, 20.34, 19.94.

Step 3

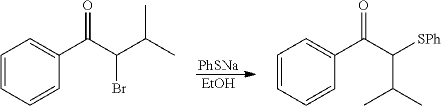

To the solution of sodium ethylate, prepared from 2.0 g (87 mmol) of Na in 150 ml of absolute ethanol, was added 10.12 g (92 mmol) of thiophenol. The reaction mixture was stirred additionally 30 min and treated with 20.1 g (83 mmol) of 2-bromo-3-methyl-1-phenyl-1-butanone. The stirring was continued for 16 h overnight at room temperature. Then the reaction mixture was poured into 600 ml of water, and extracted by hexane (3*100 ml). The combined organic phase was washed by water and dried over MgSO₄. The resulting solution was evaporated and distilled (B.p. 106° C./0.2 Torr), yielding 22.0 g (98%) of 3-methyl-1-phenyl-2-(phenylsulfanyl)-1-butanone. H¹NMR (CDCl₃, δ, 25° C.): 7.94 (d, 2H, Ph), 7.60 (t, 1H, Ph), 7.40-7.50 (m, 4H, Ph), 7.33 (m, 3H, Ph), 4.30 (d, 1H, CH), 2.41 (m, 1H, CH), 1.39 (d, 3H, CH₃), 1.08 (d, 3H, CH₃). C¹³NMR (CDCl₃, δ, 25° C): 195.92, 136.60, 133.68, 132.95, 132.67, 128.66, 128.30, 128.16, 127.98, 59.73, 29.25, 20.90, 20.33.

Step 4

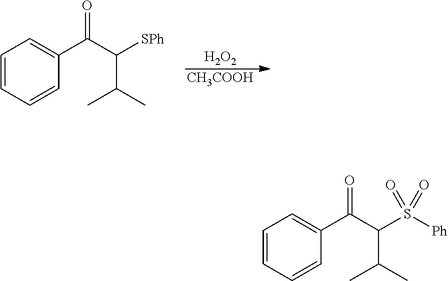

To the stirred and cooled with ice bath solution of 22.0 g (78 mmol) of 3-methyl-1-phenyl-2-(phenylsulfanyl)-1-butanone in 150 ml of acetic acid was added dropwise 31 ml g (320 mmol) of 35% H₂O₂. Then the reaction mixture was stirred for 16 h overnight at room temperature and evaporated; the residue was dissolved in 40 ml of CHCl₃ and flashchromatographed (CHCl₃, silica gel 60-200, Rf˜0.40), yielding 21.54 g (91%) of 3-methyl-1-phenyl-2-(phenylsulfonyl)-1-butanone. H¹NMR (CDCl₃, δ, 25° C.): 7.84 (m, 4H, Ph), 7.54 (t, 2H, Ph), 7.45 (m, 4H, Ph), 4.95 (d, 1H, CH), 2.63 (m, 1H, CH), 1.37 (d, 3H, CH₃), 0.93 (d, 3H, CH₃). C¹³NMR (CDCl₃, δ, 25° C.): 193.59, 137.86, 137.34, 133.77, 133.61, 129.47, 128.59, 128.54, 128.30, 75.82, 29.42, 21.26, 20.79.

Preparation of the Catalyst Components.

Each catalyst component below was prepared by the same procedure, as follows.

Into a 500 ml four-necked round flask, purged with nitrogen, 250 ml of TiCl₄ was introduced at 0° C. While stirring, 10.0 g of a microspheroidal MgCl₂.2.8C₂H₅OH adduct, and 7.4 mmoles of electron donor compound of formula (I) were added The microspheroidal adduct was prepared according to the method described in Example 2 of U.S. Pat. No. 4,399,054, which is incorporated herein by reference in it's entirety, with the only difference being in that the operating rpm used was 3,000 rpm, instead of 10,000 as disclosed in U.S. Pat. No. 4,399,054. After the microspheroidal adduct and the electron donor compounds were added, the temperature was raised to 100° C. and maintained for 120 minutes. Thereafter, stirring was discontinued, and the solid product was allowed to settle and the supernatant liquid was siphoned off.

After the supernatant was removed, 250 ml of TiCl₄ was added. The mixture was then reacted at 120° C. for 60 minutes, and then the supernatant liquid was siphoned off. The solid was washed six times with anhydrous hexane (6×100 ml) at 60° C. Finally, the solid was dried under vacuum and analyzed. The final catalyst composition is reported in Table 1.

In the catalyst components preparation of Ex. 4 was used a magnesium/internal donor molar ratio of 10 (instead of 6).

Propylene Polymerization: General Procedure

A 4-liter autoclave was purged with nitrogen flow at 70° C. for one our and then charged at 30° C. under propylene flow with 75 ml of anhydrous hexane, 760 mg of AlEt₃, 76.0 mg of dicyclopentyldimethoxysilane and 10 mg of a solid catalyst component. The autoclave was closed. Subsequently, 2.0 Nl of hydrogen were added (in the polymerization runs of Ex. 3 and comparative Ex. 1, were added 1.5 Nl of hydrogen). Then, under stirring, 1.2 Kg of liquid propylene was fed. The temperature was raised to 70° C. in five minutes and the polymerization was carried out at this temperature for two hours. The non-reacted propylene was removed; the polymer was recovered and dried at 70° C. under vacuum for three hours. The results of the polymerization runs are reported in table 2.

TABLE 1

| | Compound of formula (I) | | Ti |
|---|---|---|---|
| Ex. | Type | Wt % | Wt % |
| 1 | 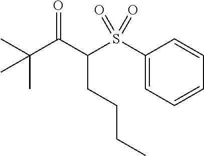 | 21.8 | 6.1 |
| 2 | 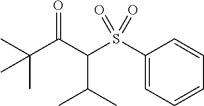 | 19.8 | 5.6 |
| Comp. 1 | 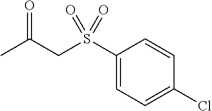 | 7.7 | 4.7 |
| 3 | 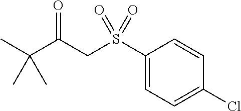 | 16.8 | 3.2 |
| 4 | 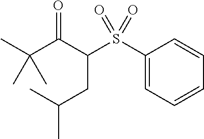 | 25.0 | 6.4 |
| 5 | 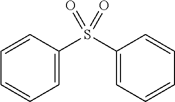 | 14.9 | 5.3 |
| 6 | 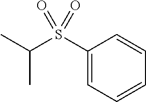 | 3.0 | 3.6 |
| 7 | 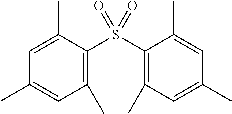 | 2.8 | 5.2 |
| 8 | 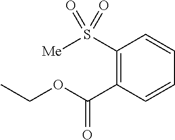 | 23.4 | 6.4 |
| 9 | 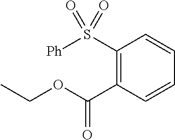 | 23.8 | 5.3 |
| 10 | 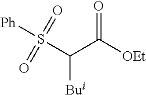 | 12.8 | 5.9 |
| 11 | 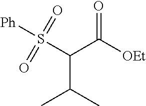 | 8.0 | 5.9 |
| 12 | 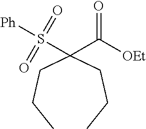 | 8.2 | 6.5 |
| 13 | 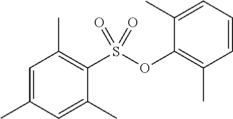 | 2.2 | 6.1 |
| 14 | 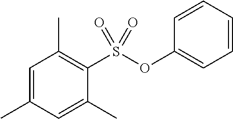 | 2.3 | 5.2 |
| Comp. 2 | 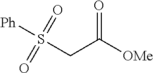 | 15.1 | 6.5 |
| Comp. 3 | 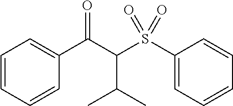 | 13.8 | 8.7 |

TABLE 2

| | | Xylene | MFR | |
|---|---|---|---|---|
| | | Insoluble | (g/10 | Polydispersity |
| Example | Mileage | (X.I.) % | minutes) | Index (P.I.) |
| 1 | 11.1 | 93.9 | 3.0 | 5.8 |
| 2 | 13.3 | 95.5 | 6.4 | 4.9 |
| Comp. 1 | 15.2 | 92.9 | 7.8 | 5.2 |
| 3 | 25.4 | 95.4 | 6.9 | 4.6 |
| 4 | 10.8 | 93.8 | 5.2 | 5.3 |
| 5 | 12.1 | 93.9 | 9.4 | 5.1 |
| 6 | 16.6 | 93.2 | 11.2 | 4.9 |
| 7 | 30.7 | 94.3 | 6.7 | 4.4 |
| 8 | 11.2 | 93.9 | 15.4 | n.d. |
| 9 | 12.6 | 96.2 | 5.5 | n.d. |
| 10 | 15.0 | 97.3 | 1.6 | 4.9 |
| 11 | 10.8 | 96.4 | 2.6 | 5.1 |
| 12 | 13.5 | 95.9 | 2.6 | 4.7 |
| 13 | 36.8 | 93.9 | 10.5 | 4.8 |
| 14 | 30.3 | 97.4 | 7.9 | 4.9 |
| Comp. 2 | 4.1 | 93.2 | n.d. | n.d. |
| Comp. 3 | 8.1 | 91.6 | 16.2 | 4.9 |

n.d. = not determined

1. A solid catalyst component for polymerizing at least one olefin comprising Mg, Ti, at least one halogen, and at least one electron donor of formula (I) 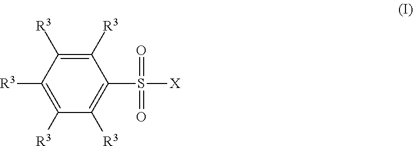
wherein
X is —OR¹, (CR²₂)—COR⁴, —(CR⁵₂)—(CR⁶₂)ₙ—COOR⁷, or R⁸;
R¹ is a C₆-C₁₀ aryl, wherein the C₆-C₁₀ aryl is optionally substituted with at least one substituent selected from hydrogen, halogens, linear or branched C₁-C₂₀ alkyls;
R² is independently hydrogen or a C₁-C₂₀ alkyl group or a cycloalkyl group;
R³ are each independently the same or different, and are hydrogen, a halogen, a —COOR⁹ group, a linear or branched C₁-C₂₀ alkyl, and a linear or branched C₂-C₂₀ alkylene, wherein the linear or branched C₁-C₂₀ alkyl or C₂-C₂₀ alkylene is optionally substituted with at least one substituent selected from hydrogen, halogens, linear or branched C₁-C₂₀ alkyls, and linear or branched C₂-C₂₀ alkylenes;
R⁴ is a C₃-C₂₀ secondary or tertiary alkyl group or a cycloalkyl group;
R⁵ and R⁶ are each independently the same or different, and are hydrogen, a halogen, a linear or branched C₁-C₂₀ alkyl, and a linear or branched C₂-C₂₀ alkylene, wherein the linear or branched C₁-C₂₀ alkyl or C₂-C₂₀ alkylene is optionally substituted with at least one substituent selected from hydrogen, halogens, linear or branched C₁-C₂₀ alkyls, and linear or branched C₂-C₂₀ alkylenes, with the proviso that the R⁵ groups cannot be simultaneously hydrogen;
R⁷ is a linear or branched C₁-C₂₀ alkyl, a C₆-C₂₀ aryl or alkylaryl and a linear or branched C₂-C₂₀ alkylene, wherein the linear or branched C₁-C₂₀ alkyl or C₂-C₂₀ alkylene is optionally substituted with at least one substituent selected from hydrogen, halogens, linear or branched C₁-C₂₀ alkyls, and linear or branched C₂-C₂₀ alkylenes;
R⁸ and R⁹ are independently a linear or branched C₁-C₂₀ alkyl, a C₆-C₁₀ aryl or a C₃-C₂₀ cycloalkyl group, wherein the C₆-C₁₀ aryl and the C₃-C₂₀ cycloalkyl group is optionally substituted with at least one substituent selected from halogens, linear or branched C₁-C₂₀ alkyls; and
n is an integer from 0 to 4;
with the proviso that when X is OR¹ at least two of R³ groups are different from hydrogen; when X is (CR²₂)—COR⁴ and if both R² are hydrogen or a primary alkyl group, at least one of R³ is different from hydrogen and when X is R⁸ and R⁸ is a linear C₁-C₂₀ alkyl at least one of R³ is different from hydrogen.

2. The solid catalyst component of claim 1 wherein X is selected from —OR¹, —(CR²₂)—COR⁴, or —(CR⁵₂)—(CR⁶₂)ₙ—COOR⁷.

3. The solid catalyst component of claim 1 wherein X is OR¹, and R¹ group is chosen from phenyl groups optionally substituted with C₁-C₁₀ hydrocarbon.

4. The solid catalyst component of claim 1 wherein X is selected from —(CR²₂)—COR⁴ groups wherein at least one of the R² groups is selected from C₃-C₁₀ alkyl groups, and R⁴ group is selected from C₄-C₁₀ tertiary alkyl groups.

5. The solid catalyst component of claim 1 wherein X is selected from —(CR⁵₂)—(CR⁶₂)ₙ—COOR⁷ where n is 0 and at least one R⁵ is selected from linear or branched C₁-C₂₀ alkyls.

6. The solid catalyst component of claim 5 wherein one R⁵ group is hydrogen and the other is selected from branched C₃-C₈ alkyl groups.

7. The solid catalyst component of claim 5 which the R⁷ groups are selected from C₁-C₁₀ hydrocarbon groups.

8. A catalyst component according to claim 1 wherein X is R⁸ and R⁸ is selected from C₆-C₁₀ aryl groups optionally substituted with one or more substituent selected from halogens, linear or branched C₁-C₂₀ alkyls.

9. A catalyst system for the polymerization of olefins obtained by contacting:
(A) a solid catalyst component according claim 1;
(B) a suitable cocatalyst and optionally
(C) an external electron donor compound.

10. A process for the polymerization of olefins carried out in the presence of the catalyst system of claim 9.
